(19) United States
(12) Patent Application Publication
(10) Pub. No.: US 2025/0174948 A1
(43) Pub. Date: May 29, 2025

(54) SHIELD CONNECTION COMPONENT

(71) Applicant: Yazaki Corporation, Tokyo (JP)

(72) Inventors: Takahiko KATSURAMAKI, Makinohara-shi (JP); Sadaharu OKUDA, Makinohara-shi (JP); Yukihiro KAWAMURA, Makinohara-shi (JP)

(73) Assignee: Yazaki Corporation, Tokyo (JP)

(21) Appl. No.: 18/938,843

(22) Filed: Nov. 6, 2024

(30) Foreign Application Priority Data
Nov. 29, 2023 (JP) 2023-201828

(51) Int. Cl. H01R 25/14; H01R 13/24; H01R 13/6582; H01R 13/6596

(52) U.S. Cl. CPC H01R 25/145; H01R 13/2492; H01R 13/6596; H01R 13/6582

(57) ABSTRACT

A shield connection component includes a first member, a conduction structure, and a second member. The first member faces a first bus bar and a second bus bar from a third direction that intersects a first and second directions. The conduction structure includes a first conduction portion in contact with a shield layer of the first bus bar, a second conduction portion in contact with a shield layer of the second bus bar, and a ground connection portion that electrically connects the first and second conduction portions to the ground. The second member is disposed on an opposite side of the first member with respect to the first and second bus bars, and when the second member is assembled with the first member, the second member presses the first bus bar toward the first conduction portion and presses the second bus bar toward the second conduction portion.

### BACKGROUND OF THE INVENTION

### Field of the Invention

Embodiments of the present invention relate to a shield connection component.

Priority is claimed on Japanese Patent Application No. 2023-201828, filed Nov. 29, 2023, the content of which is incorporated herein by reference.

### Description of Related Art

A conduction passage including a plurality of bus bars has been proposed. The conduction passage includes an insulation portion that surrounds the outer peripheries of the above plurality of bus bars, and a shield member that collectively surrounds the above plurality of bus bars and the above insulation portion.

### Prior Art Document

### Patent Document

[Patent document 1] Japanese Unexamined Patent Application, First Publication No. 2011-146237

### SUMMARY OF THE INVENTION

In a case where a plurality of bus bars is disposed, by the way, in assuming a constitution in which the plurality of bus bars individually includes shield layers, work of grounding the shield layers of the plurality of bus bars may be complicated.

According to one embodiment of the present disclosure, a shield connection component capable of improving work performance is provided.

A shield connection component in one embodiment is a component used for a routing unit including a first bus bar and a second bus bar. The first bus bar and the second bus bar each include a conductor, an insulation film that covers an outer periphery of the conductor, and a shield layer that covers an outer periphery of the insulation film. The shield connection component includes a first member, a conduction structure, and a second member. In a case where a first direction is defined as a direction in which the first bus bar and the second bus bar are disposed side by side, a second direction is defined as a direction in which an end portion of the conductor protrudes from the shield layer, and a third direction is defined as a direction that intersects the first direction and the second direction, the first member faces the first bus bar and the second bus bar from the third direction. The conduction structure includes a first conduction portion that is disposed between the first bus bar and the first member in the third direction and that is in contact with the shield layer of the first bus bar, a second conduction portion that is disposed between the second bus bar and the first member in the third direction and that is in contact with the shield layer of the second bus bar, and a ground connection portion that electrically connects the first conduction portion and the second conduction portion to ground either individually or collectively. The second member is disposed on an opposite side of the first member with respect to the first bus bar and the second bus bar, and when the second member is assembled with the first member, the second member presses the first bus bar toward the first conduction portion and presses the second bus bar toward the second conduction portion.

According to one embodiment, it becomes possible to provide a shield connection component capable of improving work performance.

### BRIEF DESCRIPTION OF THE DRAWINGS

FIG. 1 is a perspective view illustrating a routing unit in an embodiment;

FIG. 2 is an exploded perspective view illustrating a part of the routing unit in an embodiment;

FIG. 3 is a perspective view illustrating an end portion of a shield bus bar in an embodiment;

FIG. 4 is a cross-sectional view taken along line F4-F4 of the shield bus bar illustrated in FIG. 3;

FIG. 5 is a diagram illustrating the routing unit in an embodiment;

FIG. 6 is a perspective view illustrating a part of a shield connection component in a first modification of an embodiment;

FIG. 7 is a perspective view illustrating a part of a shield connection component in a second modification of an embodiment;

FIG. 8 is a perspective view illustrating a back surface of a base in the second modification of the embodiment; and

FIG. 9 is a diagram illustrating a routing unit in a third modification of an embodiment.

### DETAILED DESCRIPTION OF THE INVENTION

Hereinafter, embodiments of the present invention will be described with reference to the drawings. In the following description, constitutions having the same or similar functions are denoted by the same reference numbers. In addition, overlapping descriptions of these constitutions will be omitted, in some cases. In the present disclosure, the terms are defined as follows. A term “connection” is not limited to a mechanical connection and can include an electric connection. That is, the term “connection” is not limited to a case where two elements to be connected are directly connected and may include a case where two elements to be connected are connected with another element interposed between them.

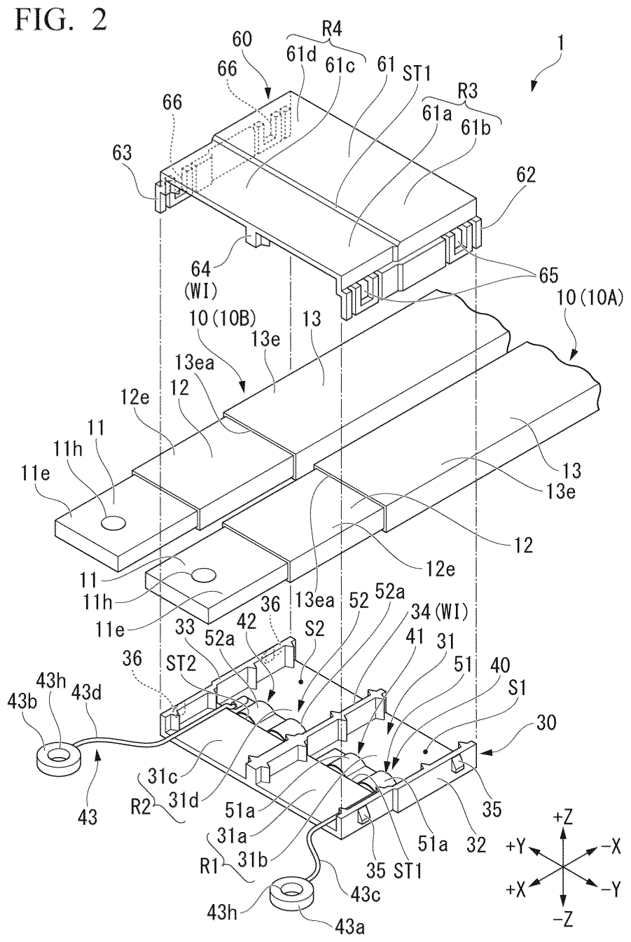

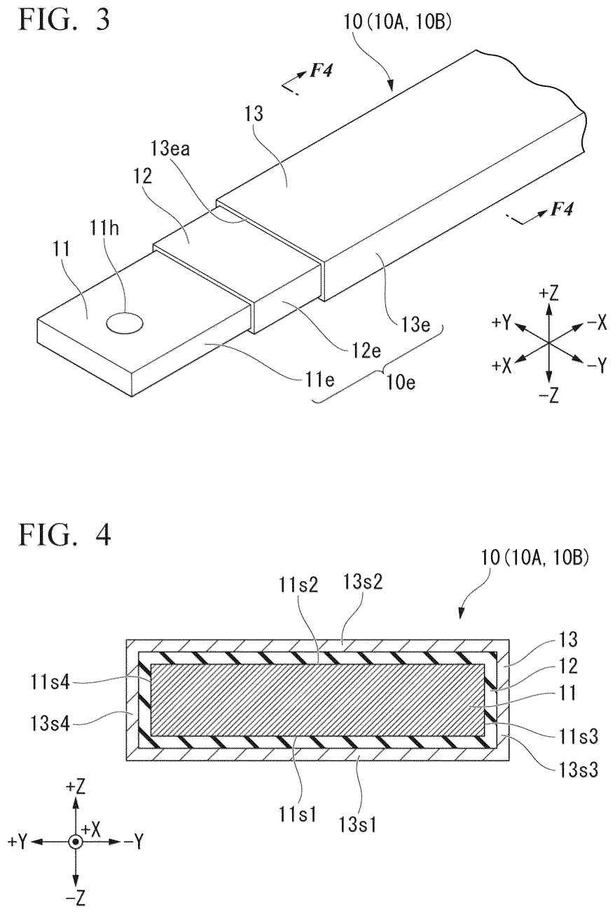

In the present disclosure, a +X direction, a −X direction, a +Y direction, a −Y direction, a +Z direction, and a −Z direction are defined as follows. The +X direction is a direction in which an end portion 11e of the conductor 11 protrudes from a shield layer 13, as will be described later (see FIG. 3). The −X direction is a direction opposite to the +X direction. In a case where the +X direction and the −X direction are not distinguished from each other, they will be simply referred to as an “X direction”. The +Y direction and the −Y direction are directions that intersect (for example, orthogonal to) the X direction. The +Y direction is a direction from a first shield bus bar 10A toward a second shield bus bar 10B, as will be described later (see FIG. 2). The −Y direction is a direction opposite to the +Y direction. In a case where the +Y direction and the −Y direction are not distinguished from each other, they will be simply referred to as a “Y direction”. The +Z direction is a direction that intersects (for example, orthogonal to) the X direction and the Y direction. The +Z direction is a direction from a base 30 toward a cover 60, as will be described later (see FIG. 2). The −Z direction is a direction opposite to the +Z direction. In a case where the +Z direction and the −Z direction are not distinguished from each other, they will be simply referred to as a “Z direction”. The Y direction is an example of a “first direction”. The X direction is an example of a “second direction”. The Z direction is an example of a “third direction”.

### Embodiments

### 1. Constitution of Routing Unit

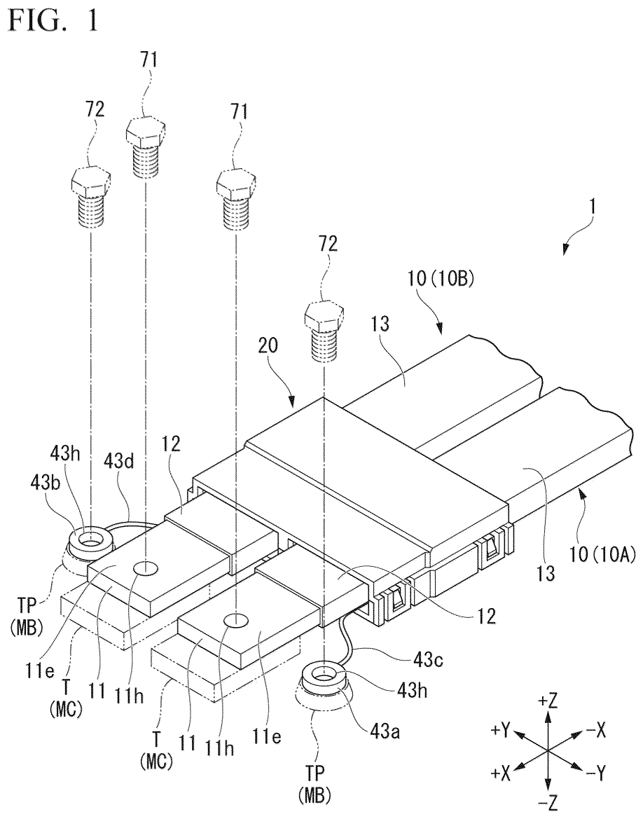

FIG. 1 is a perspective view illustrating a routing unit 1 in an embodiment. The routing unit 1 is a component for electrically connecting a plurality of components (for example, a plurality of in-vehicle components). The routing unit 1 includes, for example, a plurality of shield bus bars 10, a shield connection component 20, and fixing members 71 and 72.

### 2. Shield Bus Bar

First, the shield bus bar 10 will be described. The shield bus bar 10 is a bus bar having a shield structure. Note that in the present disclosure, the term “shield bus bar” is used for convenience of description and does not limit the scope of the invention to a specific structure.

FIG. 2 is an exploded perspective view illustrating a part of the routing unit 1. In the present embodiment, the plurality of shield bus bars 10 include a first shield bus bar 10A and a second shield bus bar 10B. The first shield bus bar 10A is an example of a “first bus bar”. The second shield bus bar 10B is an example of a “second bus bar”.

The first shield bus bar 10A and the second shield bus bar 10B have the same shapes with each other, for example. However, the first shield bus bar 10A and the second shield bus bar 10B may have different shapes from each other. Hereinafter, in a case where the first shield bus bar 10A and the second shield bus bar 10B are not distinguished from each other, they will be simply referred to as the “shield bus bar 10”.

FIG. 3 is a perspective view illustrating an end portion 10e of the shield bus bar 10. FIG. 4 is a cross-sectional view taken along line F4-F4 of the shield bus bar 10 illustrated in FIG. 3. The shield bus bar 10 includes, for example, a conductor 11, an insulation film 12, and a shield layer 13.

### 2.1 Conductor

The conductor 11 forms a conduction passage through which electric current or signals flow in the shield bus bar 10. The conductor 11 is made of metal, for example. The conductor 11 is, for example, a prismatic member having a flat rectangular cross-sectional shape.

As illustrated in FIG. 4, the conductor 11 includes a first main surface 11s1, a second main surface 11s2, a first side surface 11s3, and a second side surface 11s4. The first main surface 11s1 is positioned on an end portion of the conductor 11 on the −Z direction side. The first main surface 11s1 is a plane along the X direction and the Y direction. The second main surface 11s2 is positioned on an end portion of the conductor 11 on the +Z direction side. The second main surface 11s2 is a plane along the X direction and the Y direction. The first side surface 11s3 is positioned on an end portion of the conductor 11 on the −Y direction side. The first side surface 11s3 is a plane along the X direction and the Z direction. The second side surface 11s4 is positioned on an end portion of the conductor 11 on the +Y direction side. The second side surface 11s4 is a plane along the X direction and the Z direction. In the present embodiment, the first main surface 11s1 and the second main surface 11s2 are larger than the first side surface 11s3 and the second side surface 11s4.

As illustrated in FIG. 3, the conductor 11 includes an end portion 11e as an end portion on the +X direction side. The end portion 11e of the conductor 11 protrudes in the +X direction from an end portion 12e of the insulation film 12, as will be described later. The end portion 11e is not covered with the insulation film 12 or the shield layer 13, and is exposed to the outside of the shield bus bar 10.

As illustrated in FIG. 1, the end portion 11e is connected with a terminal T of an external component MC. The external component MC is a component with which the routing unit 1 is electrically connected. The end portion 11e includes a through hole 11h. The fixing member 71, which fixes the end portion 11e to the terminal T, passes through the through hole 11h. The fixing member 71 is, for example, a fastening member such as a bolt.

### 2.2 Insulation Film

Returning to FIGS. 3 and 4, the insulation film 12 will be described. The insulation film 12 is an insulation member that covers the outer periphery of the conductor 11. The insulation film 12 is made of, for example, a synthetic resin. For example, the insulation film 12 covers the outer periphery of the conductor 11 to surround the entire periphery of the cross-sectional shape of the conductor 11 having a flat rectangular cross-sectional shape. The insulation film 12 includes an end portion 12e as an end portion on the +X direction side. The end portion 12e of the insulation film 12 is not covered with the shield layer 13 and is exposed to the outside of the shield bus bar 10.

### 2.3 Shield Layer

The shield layer 13 is a shield portion that covers the outer periphery of the insulation film 12. The shield layer 13 is, for example, a shield portion for noise reduction. The shield layer 13 has braid or a mesh structure, a metal foil, or the like, but is not limited to them. In the present embodiment, the shield layer 13 is integrated with the conductor 11 and the insulation film 12. For example, the shield layer 13 covers the outer periphery of the insulation film 12 to surround the entire periphery of the cross-sectional shape of the conductor 11 having the flat rectangular cross-sectional shape.

As illustrated in FIG. 4, the shield layer 13 includes a first main surface portion 13s1, a second main surface portion 13s2, a first side surface portion 13s3, and a second side surface portion 13s4.

The first main surface portion 13s1 is positioned on an end portion of the shield layer 13 on the −Z direction side. The first main surface portion 13s1 is a flat portion along the X direction and the Y direction. The first main surface portion 13s1 is a flat portion along the first main surface 11s1 of the conductor 11.

The second main surface portion 13s2 is positioned on an end portion on the +Z direction side in the shield layer 13. The second main surface portion 13s2 is a flat portion along the X direction and the Y direction. The second main surface portion 13s2 is a flat portion along the second main surface 11s2 of the conductor 11.

The first side surface portion 13s3 is positioned on an end portion of the shield layer 13 on the −Y direction side. The first side surface portion 13s3 is a flat portion along the X direction and the Z direction. The first side surface portion 13s3 is a flat portion along the first side surface 11s3 of the conductor 11.

A second side surface portion 13s4 is positioned on an end portion of the shield layer 13 on the +Y direction side. The second side surface portion 13s4 is a planar portion along the X direction and the Z direction. The second side surface portion 13s4 is a flat portion along the second side surface 11s4 of the conductor 11.

Note that in the present disclosure, the “flat portion” is not limited to a flat portion in a strict sense and can include a part that can be regarded as flat in a macroscopic view. For example, even a part including a small step, dent, gap, or the like made up of braid or a mesh structure or the like can correspond to an example of the “flat portion” in the present disclosure.

The shield layer 13 includes an end portion 13e as an end portion on the +X direction side. The end portion 13e of the shield layer 13 is positioned on the −X direction side relative to the end portion 12e of the insulation film 12. The shield layer 13 is exposed to the outside of the shield bus bar 10.

### 2.4 Shape of Shield Bus Bar

In the present embodiment, the shield bus bar 10 includes the end portion 10e as an end portion on the +X direction side. The end portion 10e of the shield bus bar 10 includes, for example, the end portion 11e of the conductor 11, the end portion 12e of the insulation film 12, and the end portion 13e of the shield layer 13. In the present embodiment, the end portion 10e of the shield bus bar 10 extends linearly in the X direction.

### 2.5 Arrangement Structure of Two Shield Bus Bars

As illustrated in FIG. 2, the first shield bus bar 10A and the second shield bus bar 10B are disposed side by side in the Y direction. For example, the first shield bus bar 10A and the second shield bus bar 10B are disposed side by side in the Y direction such that short sides included in the flat rectangular cross-sectional shapes of the conductors 11 face each other.

Note that in the present disclosure, “the first bus bar and the second bus bar are disposed side by side in the first direction” is not limited to a case where the first bus bar and the second bus bar are disposed side by side in the first direction over the entire lengths of the first bus bar and the second bus bar. “The first bus bar and the second bus bar are disposed side by side in the first direction” can include a case where a part of the first bus bar (for example, the end portion 10e on the +X direction side) and a part of the second bus bar (for example, the end portion 10e on the +X direction side) are disposed side by side in the first direction, but another part of the first bus bar and another part of the second bus bar are not disposed side by side in the first direction, or the like.

### 3. Shield Connection Component

Next, the shield connection component 20 will be described with reference to FIG. 2. The shield connection component 20 is a component for grounding the shield layers 13 of the plurality of shield bus bars 10. The shield connection component 20 includes, for example, the base 30, a conduction structure 40, and the cover 60.

### 3.1 Base

The base 30 is a member that faces the plurality of shield bus bars 10 from the −Z direction. The base 30 is an example of a “first member”. The base 30 is made of an insulation material such as a synthetic resin. The base 30 includes, for example, a first main wall portion 31, a first side wall portion 32, a second side wall portion 33, and an upright wall portion 34. The base 30 is open on the +Z direction side.

### First Main Wall Portion

The first main wall portion 31 is a wall portion that faces the plurality of shield bus bars 10 (the first shield bus bar 10A and the second shield bus bar 10B) from the −Z direction. The first main wall portion 31 is, for example, a wall portion along the X direction and the Y direction. The first main wall portion 31 includes a first region R1 and a second region R2.

The first region R1 is a part that faces the first shield bus bar 10A from the −Z direction. The first region R1 defines a surface on the −Z direction side of a first accommodation portion S1 of the shield connection component 20. The first accommodation portion S1 is a space portion in which the first shield bus bar 10A is disposed in the shield connection component 20.

The second region R2 is positioned on the +Y direction side of the first region R1. The second region R2 faces the second shield bus bar 10B from the −Z direction. The second region R2 defines a surface on the −Z direction side of a second accommodation portion S2 of the shield connection component 20. The second accommodation portion S2 is a space portion in which the second shield bus bar 10B is disposed in the shield connection component 20.

In the present embodiment, the first region R1 includes a first portion 31a and a second portion 31b. The first portion 31a faces the end portion 12e of the insulation film 12 of the first shield bus bar 10A from the −Z direction. The second portion 31b faces the end portion 13e of the shield layer 13 of the first shield bus bar 10A from the −Z direction. The second portion 31b is provided to be shifted on the —Z direction side relative to the first portion 31a so that the first accommodation portion S1 is enlarged on the −Z direction side. A step portion ST1 in the Z direction is formed in a boundary between the first portion 31a and the second portion 31b. The step portion ST1 extends in the Y direction in a position corresponding to an end 13ea on the +X direction side of the shield layer 13 of the first shield bus bar 10A.

Similarly, the second region R2 includes a third portion 31c and a fourth portion 31d. The third portion 31c faces the end portion 12e of the insulation film 12 of the second shield bus bar 10B from the −Z direction. The fourth portion 31d faces the end portion 13e of the shield layer 13 of the second shield bus bar 10B from the −Z direction. The fourth portion 31d is provided to be shifted on the −Z direction side relative to the third portion 31c so that the second accommodation portion S2 is enlarged on the −Z direction side. A step portion ST2 in the Z direction is formed in a boundary between the third portion 31c and the fourth portion 31d. The step portion ST2 extends in the Y direction in a position corresponding to an end 13ea on the +X direction side of the shield layer 13 of the second shield bus bar 10B.

### First Side Wall Portion

The first side wall portion 32 is a wall portion that protrudes in the +Z direction from an end portion on the −Y direction side of the first main wall portion 31. The first side wall portion 32 defines an end portion on the −Y direction side of the base 30. The first side wall portion 32 extends along the X direction and the Z direction. The first side wall portion 32 includes, for example, a first engagement portion 35 to engage with a third side wall portion 62 of the cover 60, as will be described later. The first engagement portion 35 is, for example, a claw portion that protrudes in the −Y direction.

### Second Side Wall Portion

The second side wall portion 33 is a wall portion that protrudes in the +Z direction from an end portion on the +Y direction side of the first main wall portion 31. The second side wall portion 33 defines an end portion on the +Y direction side of the base 30. The second side wall portion 33 extends along the X direction and the Z direction. The second side wall portion 33 includes, for example, a second engagement portion 36 to engage with a fourth side wall portion 63 of the cover 60, as will be described later. The second engagement portion 36 is, for example, a claw portion that protrudes in the +Y direction.

### Upright Wall Portion

The upright wall portion 34 is a wall portion that protrudes in the +Z direction from a center portion of the first main wall portion 31 in the Y direction. The upright wall portion 34 is positioned between the first region R1 and the second region R2 of the first main wall portion 31. The upright wall portion 34 extends along the X direction and the Z direction. The upright wall portion 34 forms a part or the entirety of an insulation wall WI of the shield connection component 20. The insulation wall WI is a partition wall that partitions the inside of the shield connection component 20 into the first accommodation portion S1 and the second accommodation portion S2 so that the first shield bus bar 10A and the second shield bus bar 10B do not come into contact with each other.

### 3.2 Conduction Structure

The conduction structure 40 is a structure that electrically connects the shield layers 13 of the plurality of shield bus bars 10 to the ground. The conduction structure 40 includes, for example, a first conduction portion 41, a second conduction portion 42, and a ground connection portion 43.

### First Conduction Portion

The first conduction portion 41 is a conduction portion to be in contact with the end portion 13e of the shield layer 13 of the first shield bus bar 10A. The first conduction portion 41 is made of metal. The first conduction portion 41 is provided, for example, on an inner surface of the first main wall portion 31 of the base 30. For example, the first conduction portion 41 is provided in the first region R1 of the first main wall portion 31. For example, the first conduction portion 41 is disposed to be adjacent to the step portion ST1 in the first region R1 from the −X direction side. The first conduction portion 41 is disposed between the first main wall portion 31 of the base 30 and the shield layer 13 of the first shield bus bar 10A in the Z direction. The first conduction portion 41 comes into contact with the end portion 13e of the shield layer 13 of the first shield bus bar 10A from the −Z direction.

The first conduction portion 41 includes a first plate spring structure 51. The first plate spring structure 51 is elastically deformable in the Z direction. The first plate spring structure 51 comes into contact with the first main surface portion 13s1 of the shield layer 13 of the first shield bus bar 10A from the −Z direction.

In the present embodiment, the first plate spring structure 51 includes a plurality of plate spring portions 51a. The plurality of plate spring portions 51a each includes an arcuate portion curved to protrude on the +Z direction side and are elastically deformable in the Z direction. The plurality of plate spring portions 51a is disposed side by side in the Y direction, for example. The plurality of plate spring portions 51a comes into contact with the first main surface portion 13s1 of the shield layer 13 of the first shield bus bar 10A from the −Z direction.

### Second Conduction Portion

The second conduction portion 42 is a conduction portion to be in contact with the end portion 13e of the shield layer 13 of the second shield bus bar 10B. The second conduction portion 42 is made of metal. The second conduction portion 42 is provided, for example, on an inner surface of the first main wall portion 31 of the base 30. For example, the second conduction portion 42 is provided in the second region R2 of the first main wall portion 31. For example, the second conduction portion 42 is disposed to be adjacent to the step portion ST2 in the second region R2 from the −X direction side. The second conduction portion 42 is disposed between the first main wall portion 31 of the base 30 and the shield layer 13 of the second shield bus bar 10B in the Z direction. The second conduction portion 42 comes into contact with the end portion 13e of the shield layer 13 of the second shield bus bar 10B from the −Z direction.

The second conduction portion 42 includes a second plate spring structure 52. The second plate spring structure 52 is elastically deformable in the Z direction. The second plate spring structure 52 comes into contact with the first main surface portion 13s1 of the shield layer 13 of the second shield bus bar 10B from the −Z direction.

In the present embodiment, the second plate spring structure 52 includes a plurality of plate spring portions 52a. The plurality of plate spring portions 52a each includes an arcuate portion curved to protrude on the +Z direction side and are elastically deformable in the Z direction. The plurality of plate spring portions 52a is disposed side by side in the Y direction, for example. The plurality of plate spring portions 52a come into with the first main surface portion 13s1 of the shield layer 13 of the second shield bus bar 10B from the −Z direction.

### Ground Connection Portion

The ground connection portion 43 is an electric connection portion that electrically connects the first conduction portion 41 and the second conduction portion 42 to the ground individually or collectively. In the present embodiment, the ground connection portion 43 electrically connects the first conduction portion 41 and the second conduction portion 42 to the ground individually. The ground connection portion 43 includes, for example, a first terminal 43a, a second terminal 43b, a first lead wire 43c, and a second lead wire 43d.

The first terminal 43a is physically and electrically connected with an attachment portion TP (see FIG. 1, for example, a boss of a vehicle body panel) of an external member MB, which has ground potential. The first terminal 43a is, for example, a metal ring. The first terminal 43a includes, for example, a through hole 43h. The fixing member 72, which fixes the first terminal 43a to the attachment portion TP, passes through the through hole 43h. The fixing member 72 is, for example, a fastening member such as a bolt.

The second terminal 43b is physically and electrically connected with the attachment portion TP (see FIG. 1, for example, a boss of a vehicle body panel) of the external member MB, which has ground potential. The second terminal 43b is, for example, a metal ring. The second terminal 43b includes, for example, a through hole 43h. The fixing member 72, which fixes the second terminal 43b to the attachment portion TP, passes through the through hole 43h.

The first lead wire 43c extends between the first terminal 43a and the first conduction portion 41. The first lead wire 43c electrically connects the first terminal 43a with the first conduction portion 41. The first conduction portion 41 is electrically connected with the attachment portion TP of the external member MB through the first lead wire 43c and the first terminal 43a.

The second lead wire 43d extends between the second terminal 43b and the second conduction portion 42. The second lead wire 43d electrically connects the second terminal 43b with the second conduction portion 42. The second conduction portion 42 is electrically connected with the attachment portion TP of the external member MB through the second lead wire 43d and the second terminal 43b.

### 3.3 Cover

The cover 60 is a member disposed on an opposite side of the base 30 with respect to the plurality of shield bus bars 10. The cover 60 faces the plurality of shield bus bars 10 from the +Z direction. The cover 60 is an example of a “second member”. The cover 60 is made of an insulation material such as a synthetic resin. When the cover 60 is assembled with the base 30 (for example, when the cover 60 engages with the base 30), the cover 60 presses the end portion 13e of the shield layer 13 of the first shield bus bar 10A toward the first conduction portion 41 and presses the end portion 13e of the shield layer 13 of the second shield bus bar 10B toward the second conduction portion 42. The cover 60 includes, for example, a second main wall portion 61, a third side wall portion 62, a fourth side wall portion 63, and an upright wall portion 64. The cover 60 is open on the −Z direction side.

### Second Main Wall Portion

The second main wall portion 61 is a wall portion that faces the plurality of shield bus bars 10 (the first shield bus bar 10A and the second shield bus bar 10B) from the +Z direction. The second main wall portion 61 is, for example, a wall portion along the X direction and the Y direction. The second main wall portion 61 includes a third region R3 and a fourth region R4. The third region R3 is a part that faces the first shield bus bar 10A from the +Z direction. The third region R3 defines a surface on the +Z direction side of the first accommodation portion S1. The fourth region R4 is positioned on the +Y direction side of the third region R3. The fourth region R4 faces the second shield bus bar 10B from the +Z direction. The fourth region R4 defines a surface on the +Z direction side of the second accommodation portion S2.

In the present embodiment, the third region R3 includes a first portion 61a and a second portion 61b. In addition, the fourth region R4 includes a third portion 61c and a fourth portion 61d. Note that for details of the first portion 61a, the second portion 61b, the third portion 61c, and the fourth portion 61d, in the above description of the first portion 31a, the second portion 31b, the third portion 31c, and the fourth portion 31d, “the −Z direction” may be replaced with “the +Z direction”.

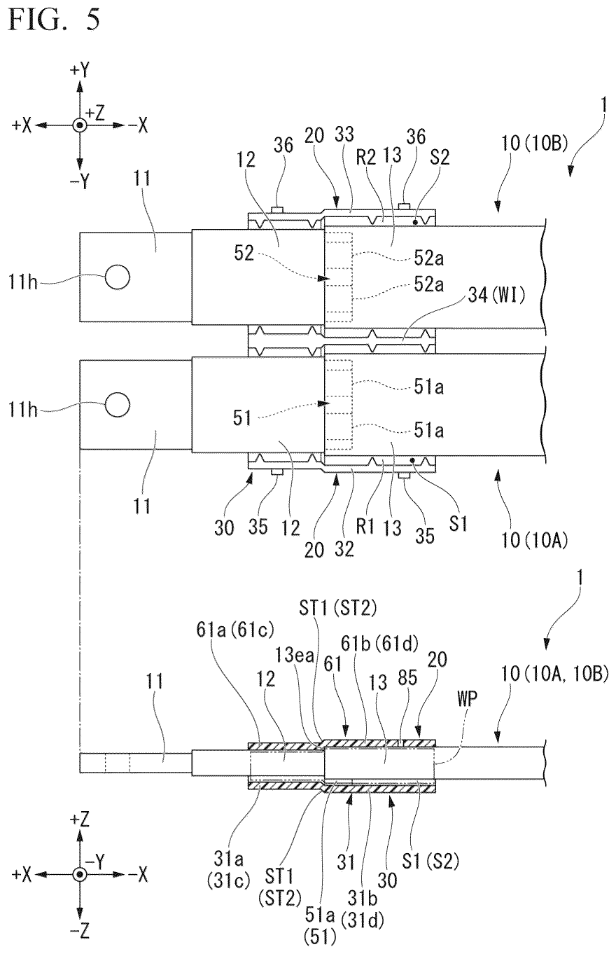

As illustrated in FIG. 5, in the present embodiment, the second portion 61b is provided to be shifted on the +Z direction side relative to the first portion 61a so that the first accommodation portion S1 is enlarged on the +Z direction side. A step portion ST1 in the Z direction is formed in a boundary between the first portion 61a and the second portion 61b. The step portion ST1 extends in the Y direction in a position corresponding to an end 13ea on the +X direction side of the shield layer 13 of the first shield bus bar 10A. Positioning of the first shield bus bar 10A is enabled, for example, by disposing the end 13ea of the shield layer 13 of the first shield bus bar 10A along the step portion ST1.

Similarly, the fourth portion 61d is provided to be shifted on the +Z direction side relative to the third portion 61c so that the second accommodation portion S2 is enlarged on the +Z direction side. A step portion ST2 in the Z direction is formed in a boundary between the third portion 61c and the fourth portion 61d. The step portion ST2 extends in the Y direction in a position corresponding to the end 13ea on the +X direction side of the shield layer 13 of the second shield bus bar 10B. Positioning of the second shield bus bar 10B is enabled, for example, by disposing the end 13ea of the shield layer 13 of the second shield bus bar 10B along the step portion ST2.

### Third Side Wall Portion

Returning to FIG. 2, the third side wall portion 62 will be described.

The third side wall portion 62 is a wall portion that protrudes in the −Z direction from an end portion on the −Y direction side of the second main wall portion 61. The third side wall portion 62 extends along the X direction and the Z direction. For example, the third side wall portion 62 is adjacent to the first side wall portion 32 from the −Y direction side. The third side wall portion 62 includes an engagement portion 65 to engage with the first side wall portion 32. The engagement portion 65 is, for example, an engagement hole to engage with the engagement portion 35 of the base 30, which is a claw portion. When the engagement portion 65 of the cover 60 and the engagement portion 35 of the base 30 engage with each other, the base 30 and the cover 60 are assembled with each other such that the second main wall portion 61 presses the plurality of shield bus bars 10 toward the conduction structure 40.

### Fourth Side Wall Portion

The fourth side wall portion 63 is a wall portion that protrudes in the −Z direction from an end portion on the +Y direction side of the second main wall portion 61. The fourth side wall portion 63 extends along the X direction and the Z direction. For example, the fourth side wall portion 63 is adjacent to the second side wall portion 33 from the +Y direction side. The fourth side wall portion 63 includes an engagement portion 66 to engage with the second side wall portion 33. The engagement portion 66 is, for example, an engagement hole to engage with the engagement portion 36 of the base 30, which is a claw portion. When the engagement portion 66 of the cover 60 and the engagement portion 36 of the base 30 engage with each other, the base 30 and the cover 60 are assembled with each other such that the second main wall portion 61 presses the plurality of shield bus bars 10 toward the conduction structure 40.

### Upright Wall Portion

The upright wall portion 64 is a wall portion that is upright in the −Z direction from a center portion of the second main wall portion 61 in the Y direction. The upright wall portion 64 is positioned between the third region R3 and the fourth region R4 of the second main wall portion 61. The upright wall portion 64 extends along the X direction and the Z direction. The upright wall portion 64 forms a part or the entirety of the insulation wall WI. In the present embodiment, the insulation wall WI is formed by assembling the upright wall portion 64 of the cover 60 with the upright wall portion 34 of the base 30. Note that instead of the above example, the insulation wall WI may be made up of only the upright wall portion 34 of the base 30 or may be made up of only the upright wall portion 64 of the cover 60.

### 3.4 Additional Waterproof Treatment

In addition to the above-described constitution, the shield connection component 20 may include a waterproof portion WP (see FIG. 5). The waterproof portion WP is a part on which waterproof treatment for suppressing corrosion of the conduction structure 40 has been performed. The waterproof portion WP is formed between the base 30 and the cover 60 with a potting material injected between the base 30 and the cover 60. For example, the waterproof portion WP is formed with the potting material injected between the base 30 and the cover 60 through an injection hole 85, which is provided in the base 30 or the cover 60.

### 4. Method for Assembling Shield Connection Component

Next, a method for assembling the shield connection component 20 will be described. First, in a state in which the base 30 and the cover 60 are separated from each other, the first shield bus bar 10A and the second shield bus bar 10B are placed inside the base 30.

Next, the cover 60 is assembled with the base 30. For example, in a state in which the plurality of shield bus bars 10 is pressed toward the conduction structure 40 by the second main wall portion 61 of the cover 60 and the first plate spring structure 51 and the second plate spring structure 52 are elastically deformed, the engagement portions 35 and 36 of the base 30 respectively engage with the engagement portions 65 and 66 of the cover 60. With this work, the shield connection component 20 is assembled, in a state in which the contact pressure between the first shield bus bar 10A and the first conduction portion 41 is ensured and the contact pressure between the second shield bus bar 10B and the second conduction portion 42 is ensured.

### 5. Advantages

As a comparative example, consideration is given to a constitution in which a plurality of bus bars individually has shield layers, and grounding components are individually attached to the shield layers of the plurality of bus bars. In the constitution of this comparative example, the work of individually attaching the grounding components to the shield layers of the plurality of bus bars becomes complicated, and work performance may be degraded.

On the other hand, in the present embodiment, the shield connection component 20 includes the base 30, the conduction structure 40, and the cover 60. The base 30 faces the first shield bus bar 10A and the second shield bus bar 10B from the Z direction. The conduction structure 40 includes the first conduction portion 41, the second conduction portion 42, and the ground connection portion 43. The first conduction portion 41 is disposed between the first shield bus bar 10A and the base 30 in the Z direction, and is in contact with the shield layer 13 of the first shield bus bar 10A. The second conduction portion 42 is disposed between the second shield bus bar 10B and the base 30 in the Z direction and is in contact with the shield layer 13 of the second shield bus bar 10B. The ground connection portion 43 electrically connects the first conduction portion 41 and the second conduction portion 42 to the ground individually or collectively. The cover 60 is disposed on an opposite side of the base 30 with respect to the first shield bus bar 10A and the second shield bus bar 10B. When the cover 60 is assembled with the base 30, the cover 60 presses the first shield bus bar 10A toward the first conduction portion 41 and presses the second shield bus bar 10B toward the second conduction portion 42.

According to such a constitution, even in a case where the plurality of shield bus bars 10 individually include the shield layers 13, work of grounding the shield layers 13 is enabled collectively. Such work is enabled, and thus the work of grounding the shield layers 13 of the plurality of shield bus bars 10 can be facilitated, as compared with a case of individually attaching the grounding components. The work of grounding the shield layers 13 of the plurality of shield bus bars 10 is enabled easily, and thus work performance can be improved.

In the present embodiment, the first conduction portion 41 has the first plate spring structure 51, which is elastically deformable in the Z direction. The second conduction portion 42 includes the second plate spring structure 52, which is elastically deformable in the Z direction. According to such a constitution, the contact pressure between the shield layer 13 of the first shield bus bar 10A and the first conduction portion 41 is ensured appropriately, and the contact pressure between the shield layer 13 of the second shield bus bar 10B and the second conduction portion 42 is easily ensured appropriately.

In the present embodiment, the shield layer 13 of the first shield bus bar 10A includes the first main surface portion 13s1 (a first flat portion) along the X direction and the Y direction. The shield layer 13 of the second shield bus bar 10B includes the first main surface portion 13s1 (a second flat portion) along the X direction and the Y direction. The first plate spring structure 51 includes the plurality of plate spring portions 51a, each of which is elastically deformable in the Z direction and is in contact with the first main surface portion 13s1 of the first shield bus bar 10A. In addition, the second plate spring structure 52 includes the plurality of plate spring portions 52a, each of which is elastically deformable in the Z direction and is in contact with the first main surface portion 13s1 of the second shield bus bar 10B. According to such a constitution, by using the constitution of the shield bus bar 10 including the flat portion, the contact between the shield layer 13 of the first shield bus bar 10A and the first conduction portion 41 is easily ensured, and the contact between the shield layer 13 of the second shield bus bar 10B and the second conduction portion 42 is easily ensured.

In the present embodiment, at least one of the base 30 and the cover 60 includes the insulation wall WI, which partitions the inside of the shield connection component 20 into the first accommodation portion S1 in which the first shield bus bar 10A is disposed and the second accommodation portion S2 in which the second shield bus bar 10B is disposed. According to such a constitution, it becomes possible to avoid contact between the first shield bus bar 10A and the second shield bus bar 10B with more certainty. In addition, by providing the insulation wall WI, arrangement spacing between the first shield bus bar 10A and the second shield bus bar 10B can be appropriately kept. The arrangement spacing can be appropriately kept, so that heat dissipation of the first shield bus bar 10A and the second shield bus bar 10B can be enhanced.

### 6. Modifications

Next, some modifications of the embodiments will be described. Note that any constitution other than constitutions to be described below in each modification is the same as the constitution in the above-described embodiments.

### 6.1 First Modification

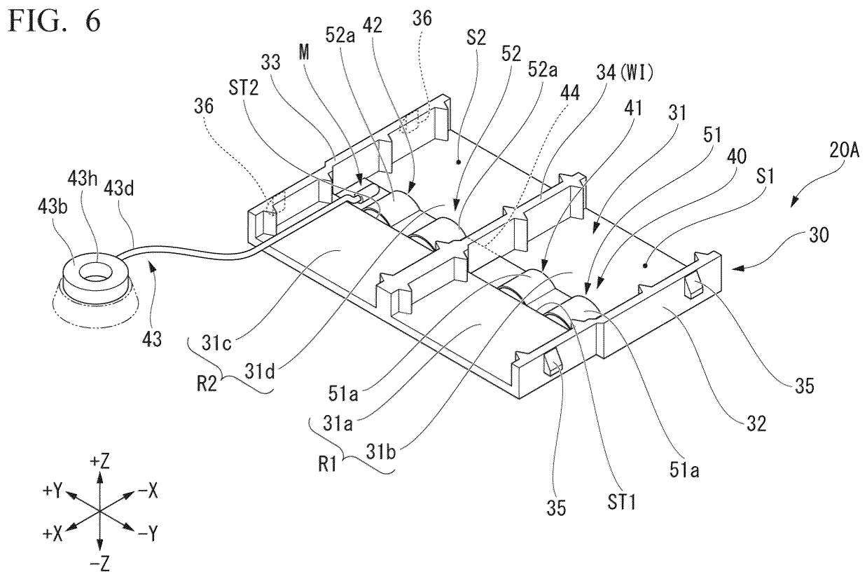

FIG. 6 is a perspective view illustrating a part of a shield connection component 20A in a first modification. In the present modification, the first conduction portion 41 and the second conduction portion 42 are coupled with each other. The first conduction portion 41 and the second conduction portion 42 are coupled with each other through a coupling portion 44, for example. For example, the coupling portion 44 penetrates through the upright wall portion 34 of the base 30 in the Y direction and extends between the first conduction portion 41 and the second conduction portion 42. The first conduction portion 41, the second conduction portion 42, and the coupling portion 44 are made up of one metal member M. The metal member M and the base 30 are integrally formed by, for example, insert molding. Note that instead of penetrating through the upright wall portion 34, the coupling portion 44 may be provided to bypass the upright wall portion 34 as in a second modification, as will be described later.

In the present modification, the ground connection portion 43 includes one terminal 43b and one lead wire 43d. In the present modification, the ground connection portion 43 electrically connects the second conduction portion 42 to the ground, thereby electrically connecting the first conduction portion 41 and the second conduction portion 42 collectively to the ground.

According to such a constitution, work is facilitated, as compared with a case where the ground connection portion 43 includes the plurality of terminals 43a and 43b.

### 6.2 Second Modification

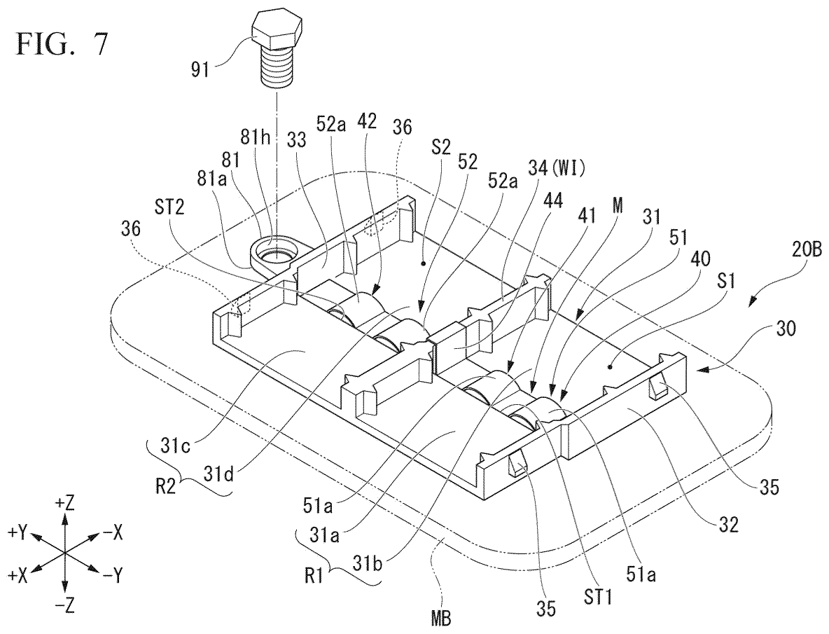

FIG. 7 is a perspective view illustrating a part of a shield connection component 20B in the second modification. In the present modification, the first conduction portion 41 and the second conduction portion 42 are coupled with each other through the coupling portion 44. The coupling portion 44 is provided to bypass the upright wall portion 34. Note that instead of bypassing the upright wall portion 34, the coupling portion 44 may penetrate through the upright wall portion 34 in the Y direction to connect the first conduction portion 41 with the second conduction portion 42 as in the first modification that has been described above.

In the present modification, at least one of the base 30 and the cover 60 includes a fixing portion 81, which fixes the shield connection component 20 to the external member MB. FIG. 7 illustrates an example in which the fixing portion 81 is provided on the base 30. The fixing portion 81 protrudes in the +Y direction from the second side wall portion 33, for example. The fixing portion 81 includes an attachment surface 81a in contact with the external member MB. The fixing portion 81 includes a through hole 81h. The through hole 81h penetrates through the fixing portion 81 in the Z direction. A fixing member 91, which fixes the fixing portion 81 to the external member MB, passes through the through hole 81h. The fixing member 91 is, for example, a fastening member such as a bolt.

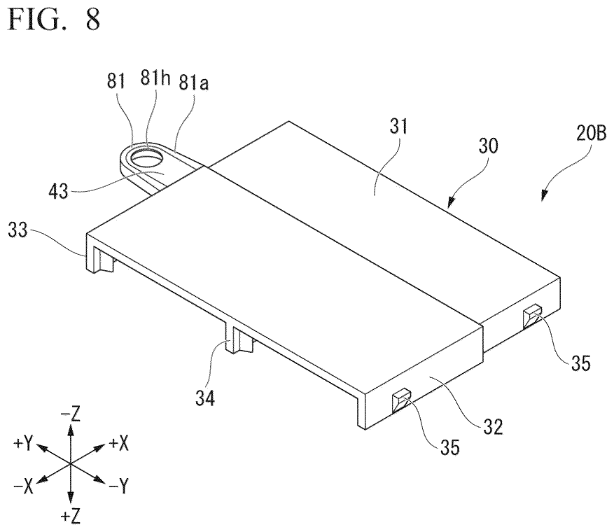

FIG. 8 is a perspective view illustrating a back surface of the base 30 in the second modification. In the present modification, the ground connection portion 43 is provided on the attachment surface 81a. For example, the ground connection portion 43 is made up of one metal member M (see FIG. 7) together with the first conduction portion 41, the second conduction portion 42, and the coupling portion 44. The ground connection portion 43 is provided on the attachment surface 81a and is exposed in the −Z direction. The fixing portion 81 is fixed to the external member MB by the fixing member 91, and thus the ground connection portion 43 comes into contact with the external member MB and is electrically connected with the external member MB. The ground connection portion 43 is electrically connected to the ground through the external member MB.

According to such a constitution, by doing the work of fixing the shield connection component 20B to the external member MB, the ground connection portion 43 can be electrically connected to the ground.

### 6.3 Third Modification

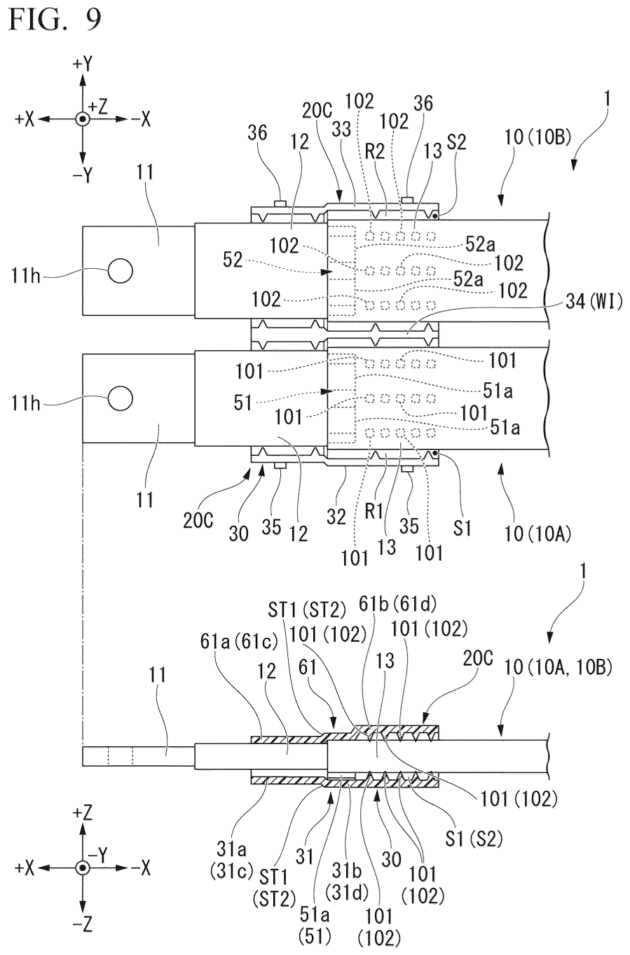

FIG. 9 is a diagram illustrating a cross-section of a shield connection component 20C in a third modification. In the present modification, the shield layer 13 of the shield bus bar 10 has braid or a mesh structure or the like, and includes a plurality of dents, gaps, or the like.

In the present modification, at least one of the base 30 and the cover 60 includes a plurality of first projections 101 and a plurality of second projections 102. In the example illustrated in FIG. 9, the base 30 and the cover 60 each include the plurality of first projections 101 and the plurality of second projections 102.

The plurality of first projections 101 project from the first main wall portion 31 or the second main wall portion 61 toward the inside of the shield connection component 20C. The plurality of first projections 101 are disposed at equal intervals in the X direction and the Y direction, for example. The plurality of first projections 101 mesh with the end portion 13e of the shield layer 13 of the first shield bus bar 10A from the Z direction.

The plurality of first projections 101 include, for example, two or more first projections 101, which are disposed in different positions with respect to the Y direction. In the present disclosure, “disposed in different positions with respect to the Y direction” is not limited to the case of being disposed side by side in the Y direction and can include a case of being disposed in positions obliquely shifted from each other with respect to the Y direction. These two or more first projections 101 mesh with the first main surface portion 13s1 or the second main surface portion 13s2 of the shield layer 13 of the first shield bus bar 10A.

Similarly, the plurality of second projections 102 project from the first main wall portion 31 or the second main wall portion 61 toward the inside of the shield connection component 20C. The plurality of second projections 102 are disposed at equal intervals in the X direction and the Y direction, for example. The plurality of second projections 102 mesh with the end portion 13e of the shield layer 13 of the second shield bus bar 10B from the Z direction.

In the present modification, the plurality of second projections 102 include two or more second projections 102, which are disposed in different positions in the Y direction. The two or more second projections 102 mesh with the first main surface portion 13s1 or the second main surface portion 13s2 of the shield layer 13 of the second shield bus bar 10B.

As described above, in the present modification, the shield connection component 20C includes the first projections 101, which mesh with the shield layer 13 of the first shield bus bar 10A, and the second projections 102, which mesh with the shield layer 13 of the second shield bus bar 10B. According to such a constitution, the first projections 101 and the second projections 102 enable the positioning of the shield bus bar 10 and/or suppression of positional deviation.

In the present modification, two or more first projections 101, which are disposed in different positions with respect to the Y direction, mesh with the first main surface portion 13s1 or the second main surface portion 13s2 of the shield layer 13 of the first shield bus bar 10A. In addition, the two or more second projections 102, which are disposed in different positions with respect to the Y direction, mesh with the first main surface portion 13s1 or the second main surface portion 13s2 of the shield layer 13 of the second shield bus bar 10B. According to such a constitution, by using the constitution of the shield bus bar 10, which includes a planar portion, the positioning of the first shield bus bar 10A and the second shield bus bar 10B and/or suppression of positional deviation are/is enabled more firmly.

Here, in attempting to provide two or more projections as described above on the base or the cover corresponding to the shield cable having a columnar shape, all the projections are to be provided to face the center of the conductor. In this case, an undercut problem occurs in the molding of the base or the cover, and it is difficult to provide the projections as described above. On the other hand, in the present embodiment, the projections 101 and 102 are provided on the base 30 or the cover 60 corresponding to the shield bus bar 10, which includes the conductor 11 having a rectangular shape, and thus the projections 101 and 102 are easily formed.

Heretofore, embodiments and a plurality of modifications have been described. However, the embodiments and the modifications are not limited to the examples described above. For example, a plurality of modifications may be achieved in combination with each other. In addition, in the embodiments that have been described above, the engagement portions 35 and 36 of the base 30 are claw portions, and the engagement portions 65 and 66 of the cover 60 are engagement holes. Alternatively, the engagement portions 65 and 66 of the cover 60 may be claw portions, and the engagement portions 35 and 36 of the base 30 may be engagement holes.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description and is only limited by the scope of the appended claims.

### INDUSTRIAL APPLICABILITY

According to the present disclosure, it becomes possible to provide a shield connection component capable of improving work performance.

### BRIEF DESCRIPTION OF THE REFERENCE SYMBOLS

1 Routing unit
10 Shield bus bar
10A First shield bus bar (first bus bar)
10B Second shield bus bar (second bus bar)
11 Conductor
12 Insulation film
13 Shield layer
20, 20A, 20B, 20C Shield connection component
30 Base (first member)
40 Conduction structure
41 First conduction portion
42 Second conduction portion
43 Ground connection portion
44 Coupling portion
51 First plate spring structure
51a Plate spring portion
52 Second plate spring structure
52a Plate spring portion
60 Cover (second member)
81 Fixing portion
81a Attachment surface
S1 First accommodation portion
S2 Second accommodation portion
WI Insulation wall

What is claimed is:

1. A shield connection component used for a routing unit including a first bus bar and a second bus bar, wherein
the first bus bar and the second bus bar each include a conductor, an insulation film that covers an outer periphery of the conductor, and a shield layer that covers an outer periphery of the insulation film,
the shield connection component comprising
a first member, a conduction structure, and a second member,
in a case where a first direction is defined as a direction in which the first bus bar and the second bus bar are disposed side by side, a second direction is defined as a direction in which an end portion of the conductor protrudes from the shield layer, and a third direction is defined as a direction that intersects the first direction and the second direction, the first member faces the first bus bar and the second bus bar from the third direction,
the conduction structure includes a first conduction portion that is disposed between the first bus bar and the first member in the third direction and that is in contact with the shield layer of the first bus bar, a second conduction portion that is disposed between the second bus bar and the first member in the third direction and that is in contact with the shield layer of the second bus bar, and a ground connection portion that electrically connects the first conduction portion and the second conduction portion to ground either individually or collectively, and
the second member is disposed on an opposite side of the first member with respect to the first bus bar and the second bus bar, and when the second member is assembled with the first member, the second member presses the first bus bar toward the first conduction portion and presses the second bus bar toward the second conduction portion.

2. The shield connection component according to claim 1, wherein
the first conduction portion includes a first plate spring structure elastically deformable in the third direction, and
the second conduction portion includes a second plate spring structure elastically deformable in the third direction.

3. The shield connection component according to claim 2, wherein
the shield layer of the first bus bar includes a first flat portion along the first direction and the second direction,
the shield layer of the second bus bar includes a second flat portion along the first direction and the second direction,
the first plate spring structure includes a plurality of plate spring portions, each of which is elastically deformable in the third direction and in contact with the first flat portion, and
the second plate spring structure includes a plurality of plate spring portions, each of which is elastically deformable in the third direction and is in contact with the second flat portion.

4. The shield connection component according to claim 1, wherein
at least one of the first member or the second member includes an insulation wall that partitions an inside of the shield connection component into a first accommodation portion in which the first bus bar is disposed and a second accommodation portion in which the second bus bar is disposed.

5. The shield connection component according to claim 1, wherein
the first conduction portion and the second conduction portion are coupled with each other, and
the ground connection portion electrically connects the second conduction portion to ground to electrically connect the first conduction portion and the second conduction portion to the ground collectively.

6. The shield connection component according to claim 1, wherein
at least one of the first member or the second member includes a fixing portion for fixing the shield connection component to an external member,
the fixing portion includes an attachment surface to be in contact with the external member, and
the ground connection portion is provided on the attachment surface.

7. The shield connection component according to claim 1, wherein
at least one of the first member and the second member includes a plurality of first projections that mesh with the shield layer of the first bus bar and a plurality of second projections that mesh with the shield layer of the second bus bar.

8. The shield connection component according to claim 7, wherein
the shield layer of the first bus bar includes a first flat portion along the first direction and the second direction,
the shield layer of the second bus bar includes a second flat portion along the first direction and the second direction,
the plurality of first projections includes two or more first projections that are disposed in different positions with respect to the first direction and that mesh with the first flat portion, and
the plurality of second projections includes two or more second projections that are disposed in different positions with respect to the first direction and that mesh with the second flat portion.
